(19) United States
(12) Patent Application Publication
(10) Pub. No.: US 2001/0035744 A1
(43) Pub. Date: Nov. 1, 2001

(54) Control device for power factor corrections

(75) Inventor: Chun-Hsiung Chen, Taoyuan City (TW)

Correspondence Address: Jackson Walker L.L.P., Suite 2100, 112 E. Pecan Street, San Antonio, TX, 78205, US

(73) Assignee: Asian Power Devices Inc.

(21) Appl. No.: 09/855,464

(22) Filed: May 15, 2001

(51) Int. Cl. G05F 1/40

(52) U.S. Cl. 323/282

(57) ABSTRACT

An improved control device for power factor corrections contains a voltage-raising circuit, a pulse width modulator to control the conduction of the voltage-raising circuit and an AC reference voltage circuit to control the output of the voltage-raising circuit. The AC reference voltage circuit consists of an error amplifier and a comparator connecting to an output port of the error amplifier. The voltage-raising circuit outputs a voltage to the error amplifier. The output port of the comparator connects to the output port of a full-wave rectifier through a set of voltage dividers and capacitor. Therefore, the output voltage of the AC reference voltage circuit conforms to the input voltage of the voltage-raising circuit, achieving the objective of correcting the power factor.

### BACKGROUND OF THE INVENTION

1. Field of Invention

The invention pertains to a power factor correction control device and, in particular, to a power factor correction control device that can be easily implemented and is cheaper.

2. Related Art

With the development of more and more intricate electronic devices, the stability requirements for power supplies have received more and more attention. For normal information appliances (communication products, electronic instruments, medical instruments, televisions, stereos, etc), the power input port first connects to a rectifying and filtering circuit and then to internal electronic circuits in the product. The conduction criteria for the diode in the rectifying and filtering circuit requires that the AC input voltage be greater than the voltage on the filter capacitor. When the criteria is satisfied, the AC input voltage can be output to a load through the rectifying and filtering circuit. The rectifying and filtering circuit is implemented in a non-resistor type filter circuit, therefore it would result in a bad power factor (about 0.55˜0.65). Not only is the bad power factor a burden on the power company generator, the product also needs the extra protection of a non-fuse type switch that allows a higher current to flow. To solve the foregoing problem, a voltage-raising circuit (composed of an inductor, a switch, and a diode) is inserted between the rectifier and the filter capacitor. When the AC voltage is lower than the filter capacitor voltage, the voltage-raising circuit extracts an electric current from the low input voltage and sends it to the filter capacitor and the load. By doing so, the voltage-raising circuit can solve the previously mentioned bad power factor problem.

To control the switch of the voltage-raising device so that the power factor correction device can achieve the objective of having the same waveform and phase for the input current and the input voltage, a control circuit has to be employed to adjust the work cycle of the switch. The control circuit uses a multiplier to multiply the output voltage of the rectifier and the output voltage of the error amplifier and then to output the signal in the type of an electric current. Therefore, when the load becomes larger, the voltage across the filter capacitor decreases. At that moment, the control circuit is used to increase the work cycle of the switch of the voltage-raising circuit so that the input voltage can provide more current to compensate for the voltage drop across the filter capacitor.

Although the control circuit uses a multiplier to achieve the goal of correcting the power factor, the cost of multipliers is high. These types of power factor correction devices really needs improvement.

### SUMMARY OF THE INVENTION

In view of the foregoing, an objective of the invention is to provide a power factor correction control device that can maintain an optimal power factor and is cheap.

To achieve the objective, the main technique of the invention is to have the power factor correction control device contain a full-wave rectifier, a voltage-raising circuit, a pulse width modulator and an AC reference voltage circuit. The full-wave rectifier connects to an AC power supply. The voltage-raising circuit is composed of a voltage-raising inductor, a switch and a diode. The pulse width modulator controls the work cycle of the switch (such as a transistor) of the voltage-raising circuit through its output port. The AC reference voltage circuit contains a comparator and an error amplifier connecting to an input port of the comparator. The output port of the error amplifier connects to the voltage output port of the voltage-raising circuit. The output port of the comparator connects to the pulse width modulator via a resistor. The resistor connects to the output port of the full-wave rectifier through a set of voltage dividers and capacitor.

When the load varies, the power factor correction circuit also makes the voltage-raising circuit change the output voltage. At that moment, the error amplifier controls the work cycle of the comparator so that the comparator outputs a correction AC reference voltage, which is then transmitted to the pulse width modulator, thus controlling the work cycle of the switch in the voltage-raising circuit. When the comparator is conducting, the resistor connecting to the pulse width modulator is equivalent to being grounded. At this point, the amplification factor of the AC reference voltage reaches its minimum. If the work cycle of the comparator is 0.5, the amplification factor of the reference voltage increases by a factor of 2. Therefore, the error amplifier extracts the voltage variation on the load to control the work cycle of the comparator, which further adjusts the voltage amplitude output from the AC reference voltage circuit. Since the AC reference voltage circuit obtains the input voltage waveform of the voltage-raising circuit through a set of voltage dividers and capacitor, it is thus able to output a correction reference voltage. The waveform, phase and frequency of the reference voltage are the same as those of the input voltage. So, the power factor correction can be achieved by utilizing the reference voltage output from the AC reference voltage circuit and controlling the voltage across the inductor to be the same as the AC reference voltage through the pulse width modulator and the switch.

### BRIEF DESCRIPTION OF THE DRAWINGS

FIG. 1 is a circuit diagram of a preferred embodiment of the power factor correction control device in accordance with the present invention;

FIG. 2 is a circuit diagram of another embodiment of the power factor correction control device in accordance with the present invention;

FIG. 3 is a circuit diagram of yet another embodiment of the power factor correction control device in accordance with the present invention; and

FIG. 4 shows a waveform of the disclosed circuit.

### DETAILED DESCRIPTION OF THE INVENTION

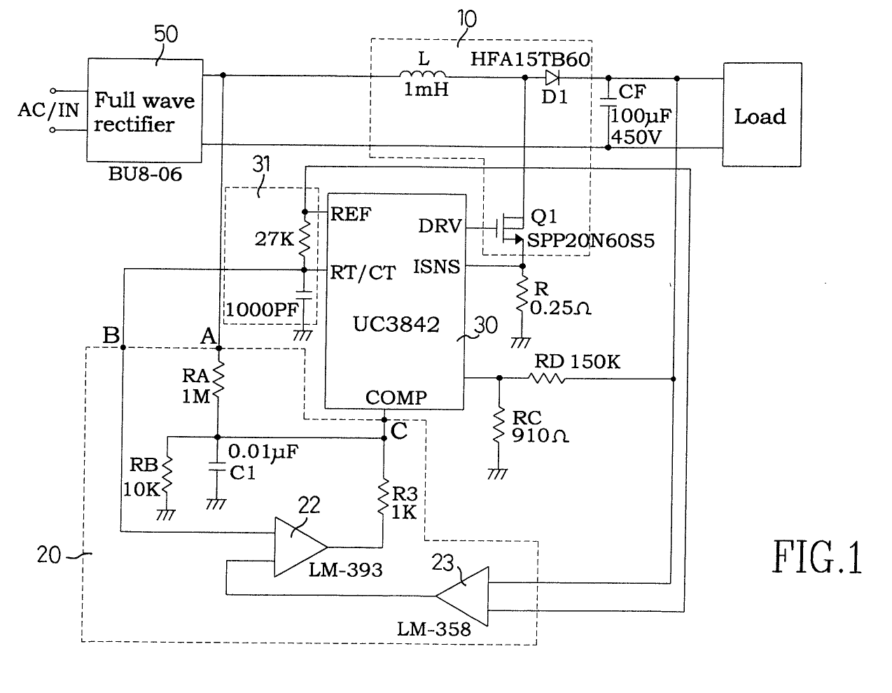

With reference to FIG. 1, a power factor correction control circuit that makes the power input port reach an optimal power factor contains a full-wave rectifier 50, a voltage-raising circuit 10, a pulse width modulator 30 and an AC reference voltage circuit 20. The full-wave rectifier 50 connects to an AC power supply. The voltage-raising circuit 10 is composed of a voltage-raising inductor L, a switch Q1 (such as a transistor) and a diode D1. The pulse width modulator 30 connects to the transistor Q1 of the voltage-raising circuit 10 through its pulse output port. Its time-sequence input port RT/CT connects to an oscillator 31. In the current embodiment of the power factor correction control circuit, when the input voltage C of the pulse width modulator 30 is 0V the duty cycle is also 0, and the duty cycle increases with the input voltage. The AC reference voltage circuit 20 contains a comparator 22 and an error amplifier 23. The output port of the comparator 22 connects to the input port COMP of the pulse width modulator 30 through a resistor R3. The resistor R3 also connects to the output port of the full-wave rectifier 50 through a set of voltage dividers RA, RB and capacitor C1. One input port of the comparator 22 connects to the oscillator 31. The output port of the error amplifier 23 connects to the other input port of the comparator 22. One of the input ports of the error amplifier 23 connects to the voltage output port of the voltage-raising circuit 10. The other input port connects to a reference voltage. In the current embodiment of the power factor correction control circuit, the reference voltage of the AC reference voltage circuit 20 is provided by the pulse width modulator 30.

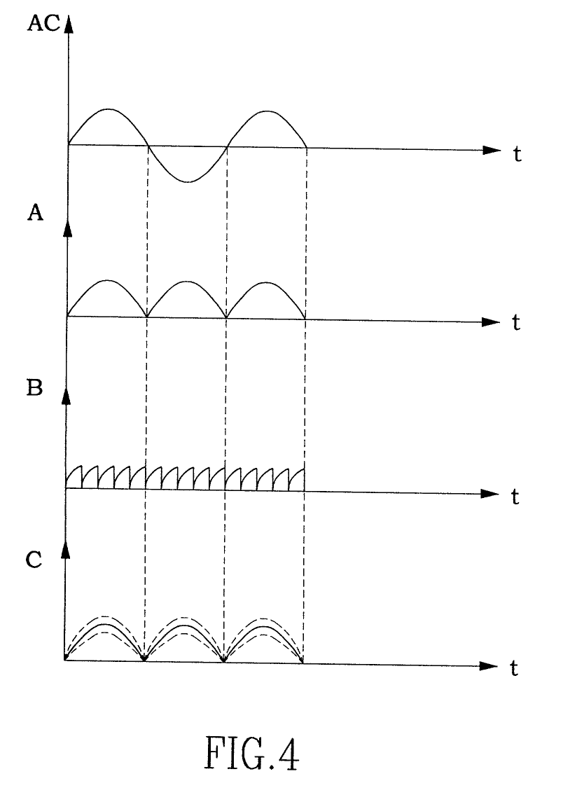

Since the output voltage of the voltage-raising circuit 10 is transmitted to an input port of the error amplifier 23 and compared with the reference voltage REF of the pulse width modulator 30, an output voltage variation value is obtained and amplified. The amplified voltage variation is then transmitted to an input port of the comparator 22 and compared with the oscillator signal of the pulse width modulator 30. Consequently, the duty cycle of the comparator 22 can be controlled via the amplified voltage variation. When the comparator 22 is conducting, the resistor R3 is virtual ground. At this time, the amplification of the reference voltage circuit 20 reaches its minimum. For example, if the duty cycle of the comparator 22 is 0.5, the equivalent resistance, which is a resistance of the resistor R3 plus the output resistance of the comparator 22, increases the amplification factor of the reference voltage circuit 20 by a factor of 2. The AC reference voltage circuit 20 outputs to the pulse width modulator 30 through the resistor R3, and the resistor R3 obtains the output voltage from the full-wave rectifier 50 through the voltage dividers RA, RB and capacitor C1. The oscillation frequency of the oscillator 31 is far greater than the AC power supply frequency. Therefore, the frequency, phase and waveform of the output voltage of the AC reference voltage circuit 20 can be adjusted to be the same as those of the input voltage of the voltage-raising circuit 10, as shown in FIG. 4.

From the above description, one knows that the waveforms, frequencies, and phases of the output voltage of the AC reference voltage circuit 20 and the input voltage of the voltage-raising circuit 1 0 are the same. The amplitudes of the output voltage of the AC reference voltage circuit are determined by the conduction percentage of the comparator 22. That is, the comparator 22 and the resistor R3 on its output port form an adjustable resistor.

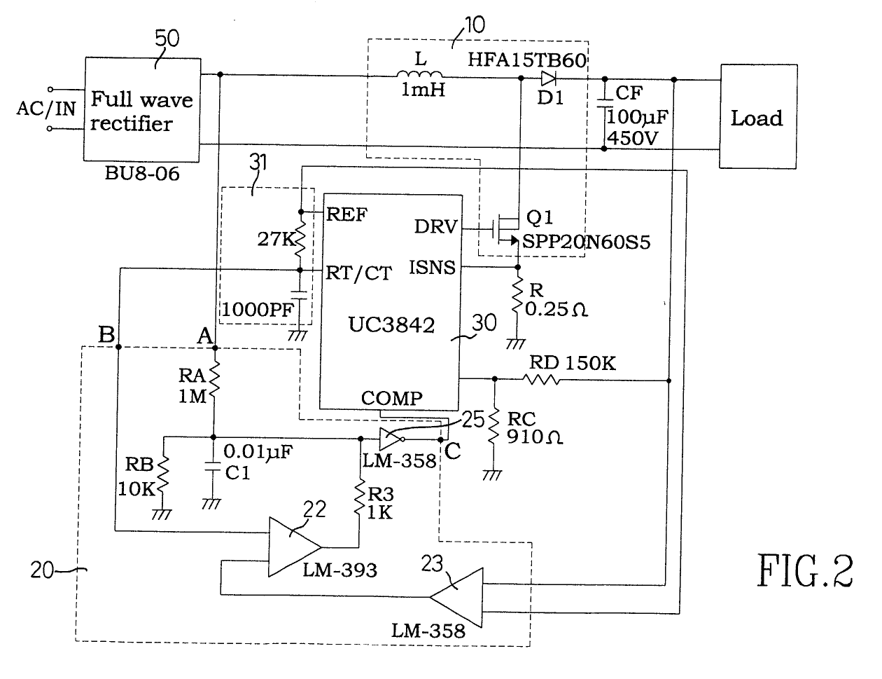

FIG. 2 shows another embodiment of the invention. The basic principles of the current power factor correction control circuit are the same as before. Since the duty cycle and output voltage of the pulse width modulator 30 in this case are opposite to the previous one, a linear inverse phase amplifier 25 is inserted between the output port of the AC reference voltage circuit 20 and the input port of the pulse width modulator 30.

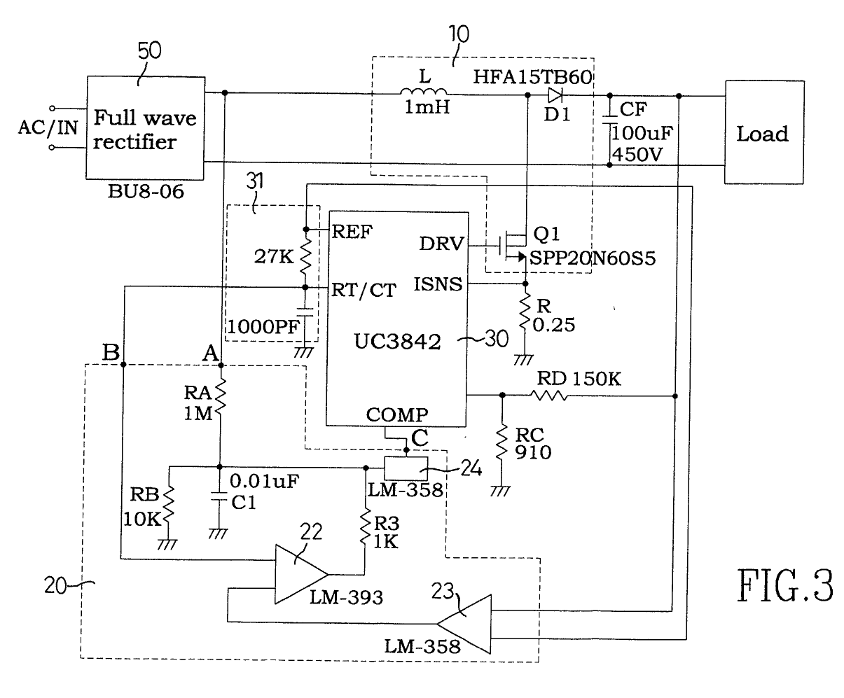

With reference to FIG. 3, the power factor correction control circuit in this embodiment is roughly the same as before. Since the input voltage of the pulse width modulator 30 includes a DC potential Vᵣ₀ when the duty cycle of the pulse width modulator 30 is zero, the output port of the AC reference voltage circuit 20 is further connected with a DC potential conversion circuit 24. The insertion of such a DC potential conversion circuit 24 adds the voltage of the DC potential Vᵣ₀ to the DC potential of the signal output from the AC reference voltage circuit 20, and then the sum is output to the input port of the pulse width modulator 30.

From the above description, one can see that the disclosed power factor correction control circuit not only makes adjustments in immediate response to the variation of the output voltage, but it also makes the adjusted power factor close to 1. Moreover, the AC reference voltage circuit only consists of a comparator, an amplifier and several passive elements so it has a relatively lower cost than other analogous circuits. With the design of the DC potential conversion circuit, it can be applied to more pulse width modulators, rendering wider applications for the invention.

The invention may be varied in many ways by a skilled person in the art. Such variations are not to be regarded as a departure from the spirit and scope of the invention, and all such modifications are intended to be included within the scope of the following claims.

What is claimed is:

1. A power factor correction control device, which comprises:
a full-wave rectifier c the AC reference voltage circuit 20onnecting to the output port of an AC power supply;
a voltage-raising circuit containing an inductor, a diode connecting to the inductor, and a switch connected between the inductor and the diode;
a pulse width modulator, whose output port connects to the switch and whose time-sequence port connects to an oscillator; and
an AC reference voltage circuit comprising:
a comparator having an output port connected to the pulse width modulator through a resistor;
an error amplifier having an output port connected to a first input port of the comparator; and
an oscillator connected to a second input port of the comparator;
wherein the resistor connecting to the output port of the comparator connects to the output port of the full-wave rectifier through a set of voltage dividers and capacitor, one input port of the error amplifier extracts the output voltage from the voltage-raising circuit and the other input port of the error amplifier connects to a reference voltage.

2. The device of claim 1, wherein an inverse phase amplifier is installed between the output port of the AC reference voltage circuit and the input port of the pulse width modulator.

3. The device of claim 1, wherein an AC potential conversion circuit is inserted between the output port of the AC reference voltage circuit and the input port of the pulse width modulator.

4. The device of claim 1, wherein the reference voltage of the error amplifier is obtained from the reference voltage output port of the pulse width modulator and the oscillator connected to the output port of the comparator is the oscillator of the pulse width modulator.

5. The device of claim 2, wherein the reference voltage of the error amplifier is obtained from the reference voltage output port of the pulse width modulator and the oscillator connected to the output port of the comparator is the oscillator of the pulse width modulator.

6. The device of claim 3, wherein the reference voltage of the error amplifier is obtained from the reference voltage output port of the pulse width modulator and the oscillator connected to the output port of the comparator is the oscillator of the pulse width modulator.

7. The device of claim 4, wherein the switch is a transistor.

8. The device of claim 5, wherein the switch is a transistor.

9. The device of claim 6, wherein the switch is a transistor.
